(19) United States
(12) Patent Application Publication
(10) Pub. No.: US 2025/0201868 A1
(43) Pub. Date: Jun. 19, 2025

(54) CELL STACK OF FUEL CELL

(71) Applicant: TOYOTA BOSHOKU KABUSHIKI KAISHA, Aichi-ken (JP)

(72) Inventor: Naohiro MATSUBARA, Susono-shi (JP)

(73) Assignee: TOYOTA BOSHOKU KABUSHIKI KAISHA, Aichi-ken (JP)

(21) Appl. No.: 18/967,891

(22) Filed: Dec. 4, 2024

(30) Foreign Application Priority Data
Dec. 14, 2023 (JP) 2023-211288

(51) Int. Cl. H01M 8/0258; H01M 4/86; H01M 8/1004

(52) U.S. Cl. CPC H01M 8/0258; H01M 4/8605; H01M 8/1004

(57) ABSTRACT

A cell stack of a fuel cell includes single cells stacked in a thickness direction. Each single cell includes a membrane electrode gas diffusion layer assembly and plate-shaped separators that sandwich the membrane electrode gas diffusion layer assembly from opposite sides in the thickness direction. Adjacent ones of the separators of the single cells, which are stacked in the thickness direction, are welded to each other at the tips of the protrusions. One of the tips of the protrusions of the adjacent separators includes a convex portion, and the other one of the tips includes a concave portion. The tips of the protrusions of the adjacent separators are in contact with each other such that the convex portion interlocks with the concave portion.

### CROSS-REFERENCE TO RELATED APPLICATIONS

This application is based upon and claims the benefit of priority from prior Japanese Patent Application No. 2023-211288, filed on Dec. 14, 2023, the entire contents of which are incorporated herein by reference.

### BACKGROUND

### 1. Field

The present disclosure relates to a cell stack of a fuel cell.

### 2. Description of Related Art

As disclosed in Japanese Laid-Open Patent Publication No. 2019-129124, a cell stack of a fuel cell is formed by stacking single cells in a thickness direction. Each single cell includes a membrane electrode gas diffusion layer assembly and multiple plate-shaped separators that sandwich the membrane electrode gas diffusion layer assembly from opposite sides in the thickness direction. Each separator includes recesses and protrusions, which are formed by bending the separator such that the recesses and the protrusions are positioned alternately. The recesses are recessed toward the membrane electrode gas diffusion layer assembly. The protrusions protrude away from the membrane electrode gas diffusion layer assembly. Adjacent ones of the separators of the single cells, which are stacked in the thickness direction, are welded to each other at the tips of the protrusions.

In each single cell, fuel gas such as hydrogen flows between one of the separators and the anode-side surface of the membrane electrode gas diffusion layer assembly. Also, oxidation gas such as air flows between the other separator and the cathode-side surface of the membrane electrode gas diffusion layer assembly. As a result, power is generated based on the reaction between the fuel gas and the oxidation gas at the membrane electrode gas diffusion layer assembly. In order to limit an increase in the temperature of the fuel cell stack caused by such power generation, the coolant, such as cooling water, flows through the space between the separators of adjacent ones of the single cells. The coolant cools the cell stack.

During the manufacturing process, fine irregularities are formed on the surfaces of the separators in each single cell. These fine irregularities also appear at the tips of the protrusions of adjacent ones of the separators that are welded together. The surface roughness at the tips of the protrusions due to these fine irregularities leads to a reduction in the degree of surface contact between the tips of the protrusions of the adjacent separators before welding. The reduced degree of surface contact between the tips of the protrusions increases the electrical resistance, specifically the contact resistance, in the single cells.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a cell stack of a fuel cell includes multiple single cells stacked in a thickness direction. Each single cell includes a membrane electrode gas diffusion layer assembly, and multiple plate-shaped separators sandwiching the membrane electrode gas diffusion layer assembly from opposite sides in the thickness direction. Each separator includes recesses and protrusions that are formed by bending the separator such that the recesses and the protrusions are positioned alternately. The recesses are recessed toward the membrane electrode gas diffusion layer assembly. The protrusions protrude away from the membrane electrode gas diffusion layer assembly. Adjacent ones of the separators of the single cells, which are stacked in the thickness direction, are welded to each other at tips of the protrusions. One of the tips of the protrusions of the adjacent separators includes a convex portion curved to bulge, and the other tip includes a concave portion curved to be dented. The tips of the protrusions of the adjacent separators are in contact with each other such that the convex portion interlocks with the concave portion.

Other features and aspects will be apparent from the following detailed description, the drawings, and the claims.

### BRIEF DESCRIPTION OF THE DRAWINGS

FIG. 1 is an exploded perspective view of a single cell.

FIG. 2 is a front view showing a state in which a separator incorporated in the single cell is viewed from the direction of arrow A in FIG. 1.

FIG. 3 is an enlarged cross-sectional view of portions corresponding to membrane electrode gas diffusion layer assemblies of adjacent separators as viewed in the direction of arrows III-III in FIG. 2.

FIG. 4 is a cross-sectional view showing a concave portion and a convex portion of the separators shown in FIG. 3 according to another example.

FIG. 5 is a cross-sectional view showing concave portions and convex portions of the separators shown in FIG. 3 according to another example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

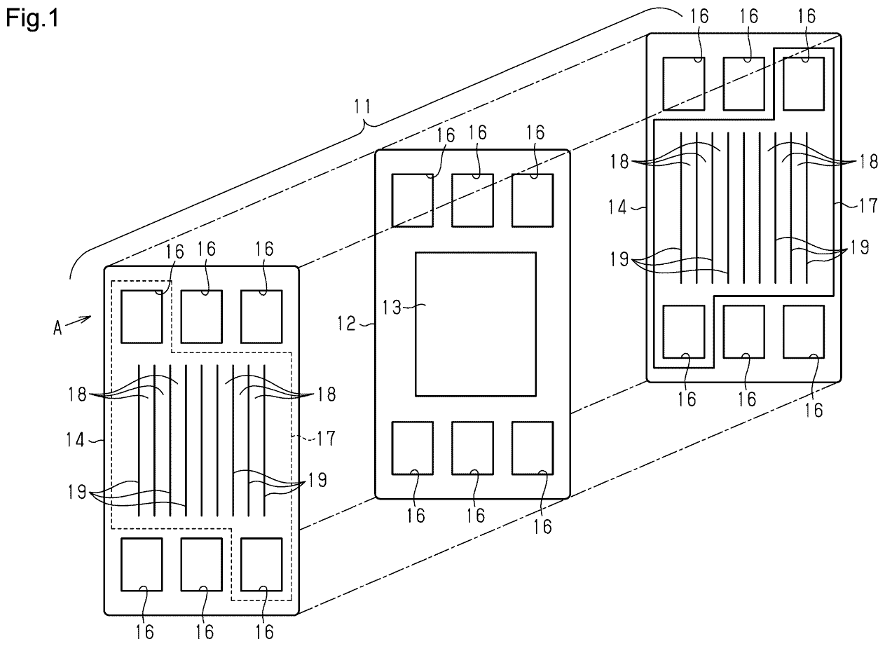

A cell stack of a fuel cell according to one embodiment will now be described with reference to FIGS. 1 to 3.

FIG. 1 shows a single cell 11 used to form a cell stack of a fuel cell. The single cell 11 includes a plastic plate 12, a membrane electrode gas diffusion layer assembly 13, and separators 14. The plastic plate 12 is formed to have the shape of a rectangular frame. The outer edge of the membrane electrode gas diffusion layer assembly 13 is joined to the plastic plate 12. The plastic plate 12 and the membrane electrode gas diffusion layer assembly 13 are sandwiched by the separators 14 from the opposite sides in the thickness direction. The separators 14 are made of metal such as stainless steel, titanium, or aluminum, and formed have the shape of a rectangular plate.

The cell stack of the fuel cell is formed by stacking the single cells 11 in the thickness direction. The plastic plates 12 and the separators 14 of the cells 11 each have holes 16. Three of the holes 16 are located at one end of the single cell 11 in the long-side direction, and the other three are located at the other end of the single cell 11 in the long-side direction. One of the holes 16 at one end in the long-side direction of the single cell 11 is paired with one of the holes 16 at the other end. Each pair of the holes 16 is used to allow a fluid (e.g. fuel gas such as hydrogen, oxidation gas such as air, or coolant) to flow therethrough. A seal member 17 is arranged between each separator 14 and the plastic plate 12. The seal members 17 are disposed on the surfaces of the plastic plate 12 on the opposite sides in the thickness direction.

The seal member 17 arranged on the front side of the plastic plate 12 surrounds pairs of the holes 16, each pair being positioned along one of the two diagonal lines of the plastic plate 12, and the corresponding separator 14. The seal member 17 also surrounds the anode-side surface of the membrane electrode gas diffusion layer assembly 13. This allows fuel gas to flow along the anode-side surface of the membrane electrode gas diffusion layer assembly 13 via the pair of the holes 16. Also, the seal member 17 arranged on the back side of the plastic plate 12 surrounds a pair of the holes 16 positioned along the other one of the two diagonal lines of the plastic plate 12 and the corresponding separator 14. The seal member 17 also surrounds the cathode-side surface of the membrane electrode gas diffusion layer assembly 13. This allows oxidation gas to flow along the cathode-side surface of the membrane electrode gas diffusion layer assembly 13 via the pair of the holes 16.

In the fuel cell stack of the single cells 11, the fuel gas flows along the anode-side surface of the membrane electrode gas diffusion layer assembly 13, and the oxidation gas flows along the cathode-side surface of the membrane electrode gas diffusion layer assembly 13. When the fuel gas and the oxidation gas respectively flow along the anode-side surface and the cathode-side surface of the membrane electrode gas diffusion layer assembly 13, power is generated based on the reaction between the fuel gas and the oxidation gas in the membrane electrode gas diffusion layer assembly 13.

### Welding of Adjacent Separators 14 (1)

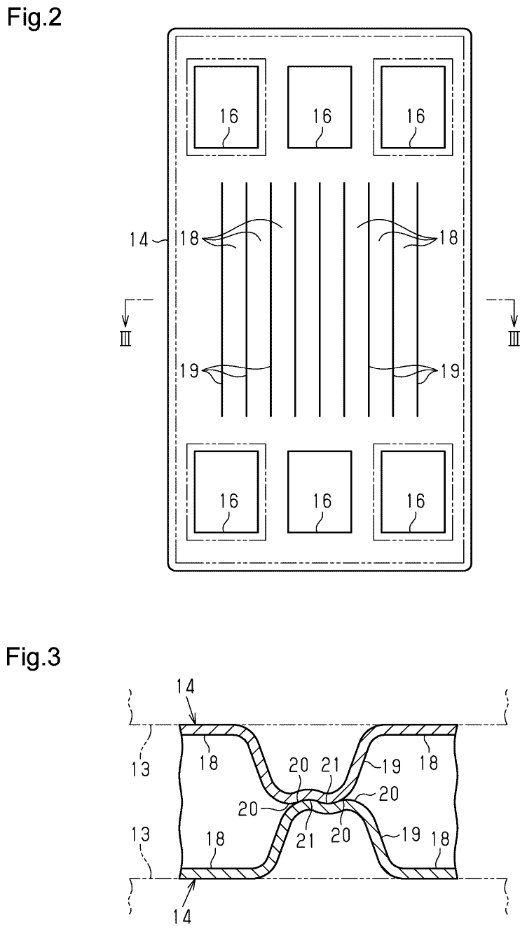

FIG. 2 shows one of the separators 14 of the single cell 11 that is located on the anode side of the membrane electrode gas diffusion layer assembly 13 as viewed in the direction of arrow A in FIG. 1. This separator 14 is adjacent to a cathode-side separator 14 of another single cell 11 that is in contact with the above-described single cell 11. Adjacent ones of the separators 14 are welded together as indicated by the long-dash double-short-dash line.

Specifically, the adjacent separators 14 are welded to each other at two sets of the holes 16 located diagonally opposite each other on the separators 14, specifically around the entire perimeter of each hole 16. Additionally, the entire outer edges of the separators 14 are welded together. This allows coolant to flow through the space between the adjacent separators 14 via the holes 16 located at the center of the separators 14 in the short-side direction. Since the coolant flows between the separators 14 of the adjacent single cells 11, the cell stack is cooled when the temperature of the cell stack rises during power generation.

### Welding of Adjacent Separators 14 (2)

FIG. 3 is an enlarged cross-sectional view of a portion corresponding to the membrane electrode gas diffusion layer assemblies 13 shown in FIG. 1 of adjacent ones of the separators 14 as viewed in the direction of arrows III-III in FIG. 2. As shown in FIG. 3, each separator 14 includes recesses 18 and protrusions 19, which are formed by bending the separator 14 such that the recesses 18 and the protrusions 19 are positioned alternately. The recesses 18 of each separator 14 are recessed toward the membrane electrode gas diffusion layer assembly 13 sandwiched between the separators 14. The protrusions 19 of each separator 14 protrude away from the membrane electrode gas diffusion layer assembly 13 sandwiched between the separators 14. As shown in FIG. 2, the recesses 18 and the protrusions 19 extend in the long-side direction of the separator 14.

Adjacent ones of the separators 14 are welded to each other by laser welding or the like at the tips of the protrusions 19. One of the tips of the protrusions 19 of the adjacent separators 14 includes a convex portion 20, which is curved to bulge, and the other tip includes a concave portion 21, which is curved to be dented. The tips of the protrusions 19 of the adjacent separators 14 are in contact with each other such that each convex portion 20 interlocks with the corresponding concave portion 21.

Specifically, the convex portions 20 and the concave portions 21 are formed at the tips of the protrusions 19 of the adjacent separators 14 as follows. Each of the protrusions 19 has convex portions 20 and a concave portion 21 at the tip. One of the tips of the protrusions 19 in contact with each other includes the concave portion 21 at a center in the width direction of the protrusion 19, and the convex portions 20 on the opposite sides in the width direction of the concave portion 21. The other one of the tips of the protrusions 19 in contact with each other includes the concave portion 21 at a center in the width direction of the protrusion 19, and the convex portions 20 on the opposite sides in the width direction of the concave portion 21.

The adjacent separators 14 are configured such that, by shifting their relative positions in the width direction of the protrusions 19, one of the convex portions 20 at one of the tips of the protrusions 19 in contact with each other interlocks with the concave portion 21 at the other one of the tips of the protrusions 19 in contact with each other. Simultaneously, one of the convex portions 20 at the other one of the tips of the protrusions 19 in contact with each other interlocks with the concave portion 21 at the one of the tips of the protrusions 19 in contact with each other. As a result, the tips of the protrusions 19 on the adjacent separators 14 are in contact with each other, with one of the convex portions 20 at one of the tips of the protrusions 19 in contact with each other interlocking with the concave portion 21 at the other one of the tips of the protrusions 19 in contact with each other, and with one of the convex portions 20 of the other one of the tips of the protrusions 19 in contact with each other interlocking with the concave portion 21 of the one of the tips of the protrusions 19 in contact with each other.

Operation and advantages of the cell stack of the fuel cell according to the present embodiment will now be described.

(1) The tips of the protrusions 19 of adjacent ones of the separators 14 are in contact with each other such that each convex portion 20 interlocks with the corresponding concave portion 21. This increases the contact area between the tips of the protrusions 19 of the adjacent separators 14. Therefore, even if the degree of surface contact between the tips of the protrusions 19 decreases due to surface roughness or other factors at the tips of the protrusions 19, the increased contact area between the tips of the protrusions 19 as described above helps prevent a significant increase in electrical resistance, specifically contact resistance, in the single cell 11.

(2) The convex portions 20 and the concave portions 21 are formed at the tips of the protrusions 19 of adjacent ones of the separators 14. The tips of the protrusions 19 on the adjacent separators 14 are in contact with each other, with the convex portion 20 at one of the tips interlocking with the concave portion 21 at the other one of the tips, and with the convex portion 20 at the other one of the tips interlocking with the concave portion 21 at the one of the tips. This readily increases the contact area between the tips of the protrusions 19.

(3) One of the tips of the protrusions 19 in contact with each other includes the concave portion 21 at a center in the width direction of the protrusion 19, and the convex portions 20 on the opposite sides in the width direction of the concave portion 21. The other one of the tips of the protrusions 19 in contact with each other includes the concave portion 21 at a center in the width direction of the protrusion 19, and the convex portions 20 on the opposite sides in the width direction of the concave portion 21. The relative positions of adjacent ones of the separators 14 are shifted in the width direction of the protrusions 19 in the following manner. Specifically, the relative positions are shifted such that one of the convex portions 20 at one of the tips of the protrusions 19 in contact with each other interlocks with the concave portion 21 at the other one of the tips of the protrusions 19 in contact with each other, and one of the convex portions 20 of the other one of the tips of the protrusions 19 in contact with each other interlocks with the concave portion 21 of the one of the tips of the protrusions 19 in contact with each other. In this case, even if the shapes of the tips of the protrusions 19 in contact with each other are the same, the contact area between the tips of the protrusions 19 is increased by shifting the relative positions of the adjacent separators 14 as described above.

The above-described embodiment may be modified as follows. The above-described embodiment and the following modifications can be combined as long as the combined modifications remain technically consistent with each other.

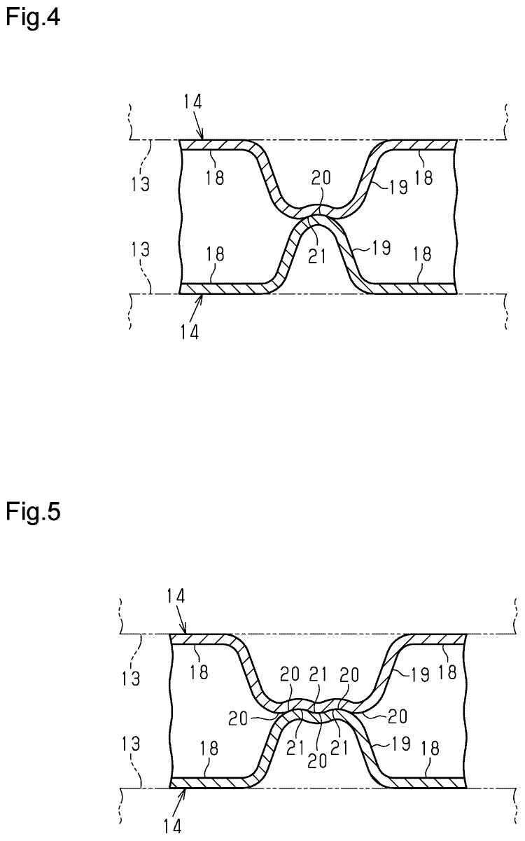

As shown in FIG. 4, one convex portion 20 may be formed at one of the tips of the protrusions 19 of adjacent separators 14, and one concave portion 21 may be formed at the other tip. In this case, the tips of the protrusions 19 of adjacent ones of the separators 14 contact each other such that the convex portion 20 at one tip interlocks with the concave portion 21 at the other tip.

Convex portions 20 and concave portions 21 may be formed as shown in FIG. 5. That is, the convex portion 20 is formed at the center in the width direction of the protrusion 19 at one of the tips of the protrusions 19 of the adjacent separators 14, and the concave portions 21 are formed on the opposite sides in the width direction of the convex portion 20. Further, a concave portion 21 is formed at the center in the width direction of the protrusion 19 at the other tip, and convex portions 20 are formed on the opposite sides in the width direction of the concave portion 21. In this case, the tips of the protrusions 19 on the adjacent separators 14 contact each other, with the convex portion 20 at one of the tips interlocking with the concave portion 21 at the other one of the tips, and the convex portions 20 of the other one of the tips interlocking with the concave portions 21 of the one of the tips.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A cell stack of a fuel cell, the cell stack comprising multiple single cells stacked in a thickness direction, wherein
each single cell includes:
a membrane electrode gas diffusion layer assembly; and
multiple plate-shaped separators sandwiching the membrane electrode gas diffusion layer assembly from opposite sides in the thickness direction,
each separator includes recesses and protrusions that are formed by bending the separator such that the recesses and the protrusions are positioned alternately,
the recesses are recessed toward the membrane electrode gas diffusion layer assembly,
the protrusions protrude away from the membrane electrode gas diffusion layer assembly,
adjacent ones of the separators of the single cells, which are stacked in the thickness direction, are welded to each other at tips of the protrusions,
one of the tips of the protrusions of the adjacent separators includes a convex portion curved to bulge, and the other tip includes a concave portion curved to be dented, and
the tips of the protrusions of the adjacent separators are in contact with each other such that the convex portion interlocks with the concave portion.

2. The cell stack of the fuel cell according to claim 1, wherein
the tips of the protrusions of the adjacent separators each include the convex portion and the concave portion, and
the tips of the protrusions of the adjacent separators are in contact with each other such that
the convex portion at one of the tips interlocks with the concave portion of the other one of the tips, and
the convex portion at the other one of the tips interlocks with the concave portion of the one of the tips.

3. The cell stack of the fuel cell according to claim 2, wherein
one of the tips of the protrusions in contact with each other includes the concave portion at a center in a width direction of the protrusion, and the convex portions on opposite sides in the width direction of the concave portion,
the other one of the tips of the protrusions in contact with each other includes the concave portion at a center in a width direction of the protrusion, and the convex portions on opposite sides in the width direction of the concave portion, and
relative positions of the adjacent separators are shifted in the width direction of the protrusions such that
one of the convex portions at one of the tips of the protrusions in contact with each other interlocks with the concave portion of the other one of the tips of the protrusions in contact with each other, and
one of the convex portions at the other one of the tips of the protrusions in contact with each other interlocks with the concave portion of the one of the tips of the protrusions in contact with each other.

4. The cell stack of the fuel cell according to claim 1, wherein
the tips of the protrusions of one of the adjacent separators each include the convex portion, the convex portion being one convex portion,
the tips of the protrusions of the other one of the adjacent separators each include the concave portion, the concave portion being one concave portion, and
the tips of the protrusions of the adjacent separators are in contact with each other such that the convex portion at the one of the tips interlocks with the concave portion at the other one of the tips.

5. The cell stack of the fuel cell according to claim 1, wherein
the tips of the protrusions of the adjacent separators each include the convex portion and the concave portion, and
one of the tips of the protrusions in contact with each other includes the convex portion at a center in a width direction of the protrusion, and the concave portions on opposite sides in the width direction of the convex portion,
the other one of the tips of the protrusions in contact with each other includes the concave portion at a center in a width direction of the protrusion, and the convex portions on opposite sides in the width direction of the concave portion, and
the tips of the protrusions of the adjacent separators are in contact with each other such that
the convex portion at the one of the tips interlocks with the concave portion of the other one of the tips, and
the convex portions at the other one of the tips interlocks with the concave portions of the one of the tips.
